(19) United States
(12) Patent Application Publication
(10) Pub. No.: US 2024/0083484 A1
(43) Pub. Date: Mar. 14, 2024

(54) BRAKE DEVICE FOR WHEEL SET OF BABY CARRIAGE

(71) Applicant: Wonderland Switzerland AG, Steinhausen (CH)

(72) Inventor: Jialiang YUAN, Guangdong (CN)

(21) Appl. No.: 18/263,195

(22) PCT Filed: Jan. 28, 2022
(86) PCT No.: PCT/EP2022/051995

§ 371 Date: Jul. 27, 2023

(30) Foreign Application Priority Data
Jan. 29, 2021 (CN) 202110133195.7

(51) Int. Cl. B62B 9/08; F16D 63/00; F16D 65/16

(52) U.S. Cl. CPC B62B 9/087; B62B 9/082; F16D 63/006; F16D 65/16; F16D 2121/14

(57) ABSTRACT

The present disclosure provides a brake device for a wheel set of a baby carriage, which including a first brake mechanism, a second brake mechanism and a traction element. The first brake mechanism is arranged on a first wheel of the baby carriage for locking or unlocking the first wheel, and the second brake mechanism is arranged on a second wheel of the baby carriage for locking or unlocking the second wheel. The traction element is connected between the first brake mechanism and the second brake mechanism. The brake device of the present disclosure may perform braking by stepping down at a side and perform unlocking by stepping down at the other side, without lifting the pedal with a foot or feet, thereby ensuring a vamp of the user to be clean.

### CROSS-REFERENCE TO RELATED APPLICATIONS

This application is a National Stage application of PCT/EP2022/051995; filed on Jan. 28, 2022, which claims the benefit of Chinese Application No. 202110133195.7, filed on Jan. 29, 2021, both of which are incorporated herein by reference in their entirety.

### TECHNICAL FIELD

The present disclosure relates to a baby carriage, in particular to a brake device for a wheel set of the baby carriage.

### BACKGROUND

The existing brake device for a wheel set of a baby carriage is generally arranged on two rear wheels, and each of the rear wheels is provided with a pedal for being stepped down. When any one of the pedals is stepped down, the other pedal may be driven by a traction element to act simultaneously, so that the two rear wheels of the baby carriage may be simultaneously stopped. When the wheels are required to be unlocked, it is only necessary to lift any one of the pedals with the user's foot to simultaneously drive both pedals and thus simultaneously unlock both rear wheels. The existing baby carriage may achieve the effect of stepping down one pedal and stopping two wheels; however, when the wheels are required to be unlocked, the user's vamp is often dirty since the user uses his/her foot to lift the pedal, and thus the user needs to clean the vamp every time after the unlocking, thereby making the user unpleasant.

### SUMMARY

A brake device for a wheel set of a baby carriage according to the present disclosure includes a first brake mechanism, a second brake mechanism and a traction element. The first brake mechanism is arranged on a first wheel of the baby carriage for locking or unlocking the first wheel, and the second brake mechanism is arranged on a second wheel of the baby carriage for locking or unlocking the second wheel. The traction element is connected between the first brake mechanism and the second brake mechanism, so that the first brake mechanism and the second brake mechanism are mutually linked when locking or unlocking, and an operating direction during locking is same as an operating direction during unlocking.

In the present disclosure, the first brake mechanism is arranged on the first wheel, the second brake mechanism is arranged on the second wheel, the first brake mechanism and the second brake mechanism are connected by a traction piece, and an operating direction during locking is the same as an operating direction during unlocking. Therefore, the locking and unlocking operations are simple and convenient, and it is not necessary to lift the pedal by the foot, thereby ensuring that the vamp of the user is clean.

When the first brake mechanism locks the first wheel, the first brake mechanism drives the second brake mechanism to lock the second wheel through the traction element, and when the second brake mechanism unlocks the second wheel, the second brake mechanism drives the first brake mechanism to unlock the first wheel through the traction element, thereby achieving the effect that the two rear wheels are simultaneously stopped by stepping down at one side to lock the rear wheels, and the two rear wheels are simultaneously unlocked by stepping down at the other side. Therefore, the operation is simple and convenient, and it is not necessary to lift the pedal by the foot.

In an embodiment, the first brake mechanism includes a first shaft pin locking or unlocking the first wheel, and the second brake mechanism includes a second shaft pin locking or unlocking the second wheel.

In an embodiment, the first brake mechanism further includes a first driver for driving the first shaft pin, the second brake mechanism further includes a second driver for driving the second shaft pin, and the traction element is connected between the first driver and the second driver.

In an embodiment, the first driver is rotatably arranged and is provided with a first driving slope at a side, the first brake mechanism further includes a first elastic element, and the first shaft pin is slidably arranged, so as to be inserted into the first wheel by pushing of the first driving slope when the first driver is rotated, or to be withdrawn from the first wheel under an elastic force of the first elastic element.

In an embodiment, the first driving slope is provided with a locking position at an end thereof and a locking release position at the other end.

In an embodiment, the first driver is provided with an arc-shaped guide hole for guiding its rotation.

In an embodiment, the first driver is provided with a first operating member for driving the first driver to rotate.

In an embodiment, the second driver is rotatably arranged and is provided with a second driving slope at a side, the second brake mechanism further includes a second elastic element, and the second shaft pin is slidably arranged, so as to be inserted into the second wheel by pushing of the second driving slope when the second driver is rotated, or to be withdrawn from the second wheel under an elastic force of the second elastic element.

In an embodiment, the second driver is provided with a driving inclined hole, and the second brake mechanism further includes a third elastic element providing an elastic force to reset the second driver, and a second operating member having a shaft pin slidably inserted into the driving inclined hole.

In an embodiment, the second driving slope is provided with a locking position at an end thereof and an unlocking position at the other end.

In an embodiment, when the first brake mechanism locks the first wheel, the first brake mechanism drives the second brake mechanism to lock the second wheel, and when the first brake mechanism unlocks the first wheel, the first brake mechanism drives the second brake mechanism to unlock the second wheel.

In an embodiment, the first brake mechanism further includes an engaging hook, the first driver is provided with a first guide groove and a second guide groove, an engaging position and an unlocking position are arranged between the first guide groove and the second guide groove, an end of the engaging hook is fixed on a frame of the baby carriage, and the other end of the engaging hook is slidably arranged in any one of the first guide groove and the second guide groove; when the first driver rotates and pushes the first shaft pin to lock the first wheel, the engaging hook slides from the first guide groove to the engaging position; and when the first driver rotates and pushes the first shaft pin to unlock the first wheel, the engaging hook slides from the engaging position to the unlocking position.

A fixing hole is provided on the frame of the baby carriage, and an end of the engaging hook is connected to the fixing hole. The fixing hole may limit an end of the engaging hook, and also ensure that the engaging hook may be rotated for a certain angle when sliding in the guide grooves, thereby enhancing the flexibility of the engaging hook.

In an embodiment, the first driver is further provided with a third guide groove and a fourth guide groove, both ends of the third guide groove are connected with the first guide groove and the engaging position, and both ends of the fourth guide groove are connected with the engaging position and the second guide groove.

In an embodiment, a guide slope is provided between the fourth guide groove and the second guide groove for sliding the engaging hook to the second guide groove. Since the engaging hook may be deformed when the engaging hook slides upward on the fourth guide groove to perform the unlocking, and a groove wall of the fourth guide groove is crushed, the engaging hook may automatically and quickly slide into the second guide groove by providing the guide slope, thereby avoiding the engaging hook from being deformed and preventing the groove wall of the fourth guide groove from being crushed, and prolonging the service life.

### BRIEF DESCRIPTION OF THE DRAWINGS

FIG. 1 is a structural view of a brake device for a wheel set of a baby carriage according to a first embodiment of the present disclosure.

FIG. 2 is a structural view of a first brake mechanism according to the first embodiment of the present disclosure.

FIG. 3 is a structural view of a first driver according to the first embodiment of the present disclosure.

FIG. 4 is a structural view of a second brake mechanism according to the first embodiment of the present disclosure.

FIG. 5 is a structural view of a second driver according to the first embodiment of the present disclosure.

FIG. 6 is a state diagram of the first brake mechanism when braking according to the first embodiment of the present disclosure.

FIG. 7 is a state structural diagram of the second brake mechanism when braking according to the first embodiment of the present disclosure.

FIG. 8 is a structural view of a brake device for a wheel set of a baby carriage according to a second embodiment of the present disclosure.

FIG. 9 is another structural view of a brake device for a wheel set of a baby carriage according to the second embodiment of the present disclosure.

FIG. 10 is a perspective view of a first brake mechanism according to the second embodiment of the present disclosure.

FIG. 11 is a side view of the first brake mechanism according to the second embodiment of the present disclosure.

FIG. 12 is a structural view of a first driver according to the second embodiment of the present disclosure.

FIG. 13 is a structural view of a brake device for a wheel set of a baby carriage when braking according to a third embodiment of the present disclosure.

FIG. 14 is a structural view of the brake device of the wheel set of the baby carriage when unlocking according to the third embodiment of the present disclosure.

FIG. 15 is a structural view of a driving mechanism installed on a frame of a baby carriage according to the third embodiment of the present disclosure.

FIG. 16A is a structural view of the driving mechanism in FIG. 15 with a part of a fixed seat removed.

FIG. 16B is a cross-sectional view of the driving mechanism in FIG. 16A when a body portion of the third driver is partially cut away.

FIGS. 17A and 17B are partially enlarged side views of the third driver according to the third embodiment of the present disclosure.

FIG. 18 shows a position of a torsion spring head in an annular groove of a guide side surface of the third driver when the third driver is in an initial position according to the third embodiment of the present disclosure.

FIG. 19 shows a position of the torsion spring head in the annular groove of the guide side surface of the third driver when the third driver starts to pivot in a first direction under a first operation according to the third embodiment of the present disclosure.

FIG. 20 shows a position of the torsion spring head in the annular groove of the guide side surface of the third driver when the third driver pivots to an end position in the first direction according to the third embodiment of the present disclosure.

FIG. 21 shows a position of the torsion spring head in the annular groove of the guide side surface of the third driver when the third driver pivots to a locking position in a second direction according to the third embodiment of the present disclosure.

FIGS. 22 and 23 show positions of the torsion spring head in the annular groove of the guide side surface of the third driver when the third driver continues to rotate in the first direction under a second operation according to the third embodiment of the present disclosure.

FIG. 24 shows an example of the annular groove of the guide side surface of the third driver according to the third embodiment of the present disclosure.

FIG. 25 shows a position of the torsion spring head in the annular groove shown in FIG. 24 when the third driver pivots to the end position in the first direction according to the third embodiment of the present disclosure.

FIG. 26 shows another side of the third driver according to the third embodiment of the present disclosure.

FIG. 27 shows an internal structural view of the driving mechanism with the third driver removed according to the third embodiment of the present disclosure.

FIG. 28 shows an internal structural view of the driving mechanism with a bottom of the third driver removed according to the third embodiment of the present disclosure.

FIG. 29 shows a structural view of the driving mechanism without the bottom of the third driver removed according to the third embodiment of the present disclosure.

FIG. 30 is an exploded structural view of the driving mechanism and the first brake mechanism according to the third embodiment of the present disclosure.

FIG. 31 is a matching structural view of the driving mechanism and the traction element according to the third embodiment of the present disclosure.

FIG. 32 is an internal structural view of the third driver according to the third embodiment of the present disclosure.

FIG. 33 is a structural view of the driving mechanism and the first brake mechanism according to the third embodiment of the present disclosure.

FIG. 34 is a structural view of a part of the first brake mechanism according to the third embodiment of the present disclosure.

100—brake device for wheel set of baby carriage;
101—first rear wheel;
102—second rear wheel;
103—first rear wheel seat;
104—second rear wheel seat;
1—first brake mechanism;
2—second brake mechanism;
3—traction element;
11—first shaft pin;
12—first driver 12;
13—first elastic element 13;
21—second shaft pin;
22—second driver;
23—second elastic element;
24—first elastic element;
25—third elastic element;
121—first driving slope;
122—locking position;
123—unlocking position;
124—arc-shaped guide hole;
125—first operating member;
221—driving inclined hole;
222—second driving slope;
223—locking position;
224—unlocking position;
241—shaft pin;
100′—brake device for wheel set of baby carriage;
1′—first brake mechanism;
2′—second brake mechanism;
3′—traction element;
11′—first shaft pin;
12′—first driver;
13′—engaging hook;
14′—first elastic element;
121′—first guide groove;
122′—second guide groove;
123′—engaging position;
124′—unlocking position;
125′—third guide groove;
126′—fourth guide groove;
127′—first driving slope;
128′—pedal;
129′—guide slope;
1031—fixing hole;
100″—brake device for wheel set of baby carriage;
F—frame;
101″—first wheel;
102″—second wheel;
1″—first brake mechanism;
11″—locking member;
13″—sliding sleeve;
131″—traction portion;
132″—through chute;
14″—elastic return element;
15″—locking groove structure;
151″—locking groove;
2″—second brake mechanism;
3″—traction member;
31″—driving pin;
31a″—sliding shaft;
32″—elastic element;
4—driving mechanism;
41—fixed seat;
42—third driver;
421—body portion;
421a—driving chute;
422—third operating member;
423—guide side surface;
423a—first guide groove;
423b—second guide groove;
423c—engaging groove;
423c1—recess;
423c21, 423c22—two sections of engaging groove;
423d—unlocking groove;
43—engaging torsion spring;
431—fixed portion;
432—torsion spring head;
433—fixed torsion spring head;
44—return torsion spring;
441—first end of return spring;
442—second end of return spring.

### DETAILED DESCRIPTION

In order to explain the technical contents, the structural features and the achieved effects of the present disclosure in detail, the following detailed description will be made in combination with the embodiments and accompanying drawings.

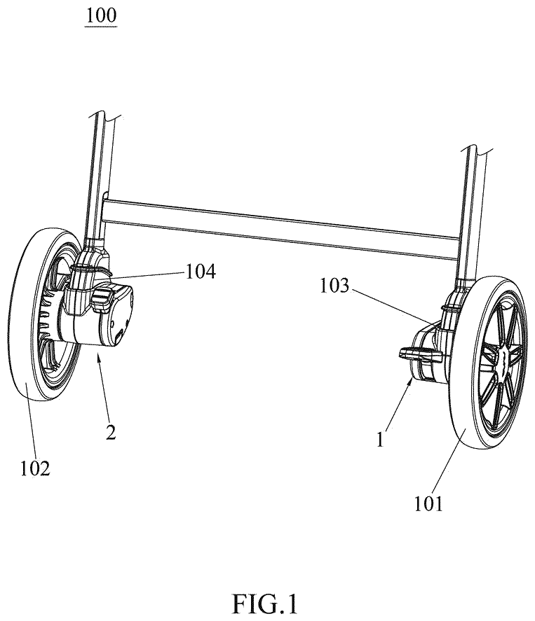

As shown in FIG. 1, a structure of a brake device 100 for a wheel set of a baby carriage according to a first embodiment of the present disclosure is shown.

The brake device 100 of the present disclosure is installed at a rear side of the baby carriage, and includes a first brake mechanism 1, a second brake mechanism 2 and a traction element 3. The first brake mechanism 1 is arranged on a first rear wheel seat 103 of a frame of the baby carriage for locking a first rear wheel 101, and the second brake mechanism 2 is arranged on a second rear wheel seat 104 of the frame of the baby carriage for unlocking a second rear wheel 102. The traction element 3 is connected between the first brake mechanism 1 and the second brake mechanism 2, so that the first brake mechanism 1 and the second brake mechanism 2 are mutually linked when locking or unlocking, so as to drive the second brake mechanism 2 to lock the second rear wheel 102 when the first brake mechanism 1 locks the first rear wheel 101, or drive the first brake mechanism 1 to unlock the first rear wheel 101 when the second brake mechanism 2 unlocks the second rear wheel 102. An operating direction of the first brake mechanism 1 during locking is the same as an operating direction of the second brake mechanism 2 during unlocking.

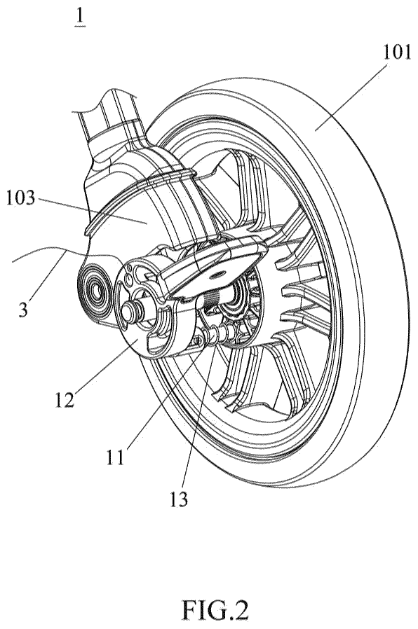

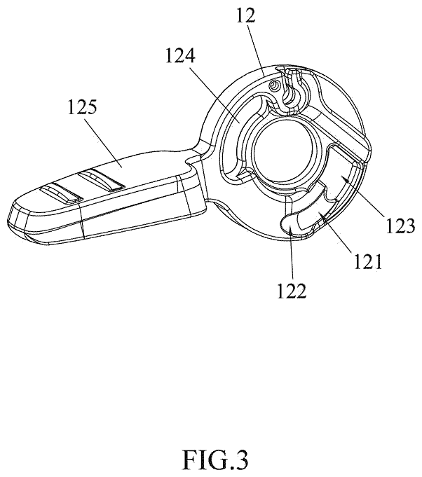

As shown in FIGS. 2 to 4, the first brake mechanism 1 includes a first shaft pin 11, a first driver 12 for driving the first shaft pin 11, and a first elastic element 13. The first elastic element 13 is a compression spring, and the first shaft pin 11 is configured to lock the first rear wheel 101. The second brake mechanism 2 includes a second shaft pin 21 and a second driver 22 for driving the second shaft pin 21. The second shaft pin 21 is configured to lock the second rear wheel 102. The traction element 3 is connected between the first driver 12 and the second driver 22. In an embodiment, the first driver 12 is rotatably arranged on the first rear wheel seat 103, and is provided with a first driving slope 121 at a side of the first driver 12. The first shaft pin 11 is slidably arranged on the first rear wheel seat 103, and an end of the first shaft pin 11 is slidably abutted against the first driving slope 121. The first elastic element 13 is arranged in the first rear wheel seat 103 and provides an elastic force for the first shaft pin 11 to be inserted into the first rear wheel 101. The first shaft pin 11 may be inserted into the first rear wheel 101 by pushing of the first driving slope 121 when the first driver 12 is rotated, or may be withdrawn from the first rear wheel 101 under the elastic force of the first elastic element 13. The first driving slope 121 is provided with a locking position 122 at an end, and an unlocking position 123 at the other end. When the first driver 12 is placed horizontally, the locking position 122 is located at a high position of the first driver 12, and the unlocking position 123 is located at a low position of the first driver 12. When an end of the first shaft pin 11 is inserted into the first rear wheel 101, the other end of the first shaft pin 11 is positioned at the locking position 122, and when an end of the first shaft pin 11 is withdrawn from the first rear wheel 101, the other end of the first shaft pin 11 is positioned at the unlocking position 123. The first driver 12 is provided with an arc-shaped guide hole 124 for guiding its rotation. A guide post is provided in the first rear wheel seat 103, and is slidably inserted into the arc-shaped guide hole 124. A first operating member 125 is provided on the first driver 12 for the user to conveniently step down with his/her foot/feet.

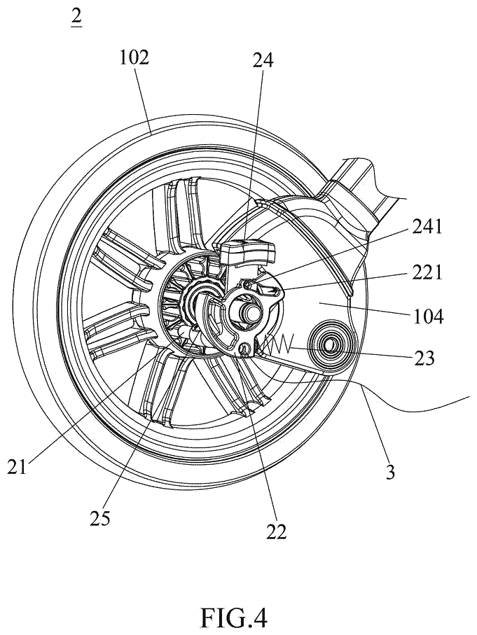

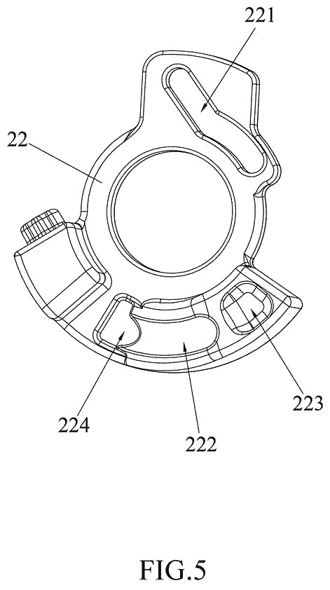

Referring to FIGS. 4 and 5 again, the second driver 22 is rotatably arranged on the second rear wheel seat 104. The second driver 22 is provided with a driving inclined hole 221. The second brake mechanism 2 also includes a third elastic element 23 and a second operating member 24. The second operating member 24 has a shaft pin 241, and the shaft pin is slidably inserted into the driving inclined hole 221. The third elastic element 23 is arranged between the second rear wheel seat 104 and the second driver 22, and provides an elastic force to rotate and reset the second driver 22. The third elastic element 23 is a compression spring. In an embodiment, the second driver 22 is provided with a second driving slope 222 at a side thereof. The second brake mechanism 2 also includes a second elastic element 25, the second shaft pin 21 is slidably arranged on the second rear wheel seat 104, and the second elastic element 25 is arranged on the second rear wheel seat 104 and sleeved with the second shaft pin 21 to provide an elastic force for resetting the second shaft pin 21. The second shaft pin 21 may be inserted into the second rear wheel 102 by pushing of the second driving slope 222 when the second driver 22 is rotated, or may be withdrawn from the second rear wheel 102 by the elastic force of the second elastic element 25. In an embodiment, the second driving slope 222 is provided with a locking position 223 at an end thereof and a locking release position 224 at the other end. When the second driver 22 is placed horizontally, the locking position 223 is located at a high position of the second driver 22, and the unlocking position 224 is located at a low position of the second driver 22. When an end of the second shaft pin 21 is inserted into the second rear wheel 102, the other end of the second shaft pin 21 is located at the locking position 223, and when an end of the second shaft pin 21 is withdrawn from the second rear wheel 102, the other end of the second shaft pin 21 is located at the unlocking position 224.

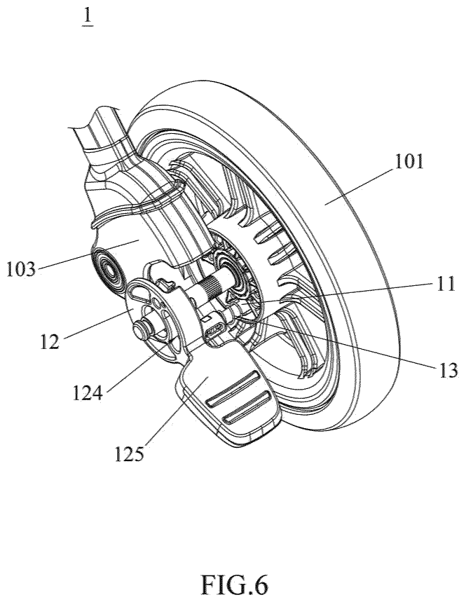

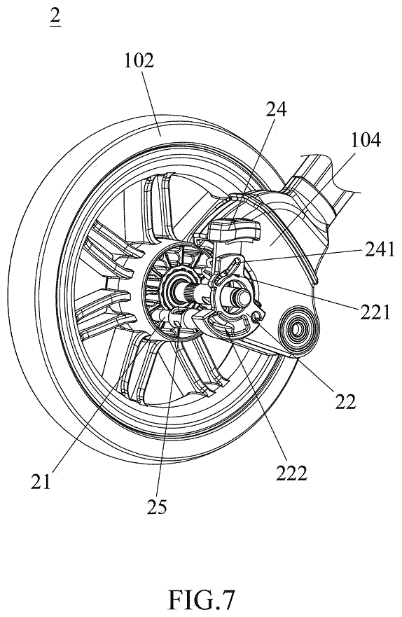

Based on the above and in combination with FIGS. 6 and 7, the working principle of the brake device 100 for the wheel set of the baby carriage of this embodiment will be described in detail as follows.

When it is necessary to perform the braking, a pedal on the first driver 12 is stepped down by the foot, and the first driver 12 is rotated. At this time, the first driving slope 121 and the first shaft pin 11 relatively slide, and the first shaft pin 11 slides from the unlocking position 123 to the locking position 122 along the first driving slope 121. In this process, the first driving slope 121 drives the first shaft pin 11 to be inserted into the first rear wheel 101, thereby stopping the first rear wheel 101. The first driver 12 pulls the traction element 3 while the first driver 12 is rotated, and the traction element 3 drives the second driver 22 to rotate. The second driving slope 222 of the second driver 22 drives the second shaft pin 21 to be inserted into the second rear wheel 102, and the second shaft pin 21 slides from the unlocking position 224 to the locking position 223 along the second driving slope 222. At this time, the first rear wheel 101 and the second rear wheel 102 are simultaneously locked.

When it is necessary to perform the unlocking, the second operating member 24 at the other side is stepped down with the user's foot, so that the second operating member 24 moves downward. The shaft pin 241 on the second operating member 24 slides in the driving inclined hole 221 and drives the second driver 22 to rotate. The second driver 22 drives the second driving slope 222 to rotate, and under the elastic force of the second elastic element 25, the second shaft pin 21 slides from the locking position 223 to the unlocking position 224. The other end of the second shaft pin 21 is withdrawn from the second rear wheel 102. At the same time, the second driver 22 drives the first driver 12 to rotate through the traction element 3, so that the first driver 12 drives the first driving slope 121 to rotate, and under the elastic force of the first elastic element 13, the first shaft pin 11 slides from the locking position 122 to the unlocking position 123. The other end of the first shaft pin 11 is withdrawn from the first rear wheel 101. At this time, the first rear wheel 101 and the second rear wheel 102 are simultaneously unlocked.

In brief, the operation direction of stepping down the first operating member 125 with the foot when braking is the same as that of stepping down the second operating member 24 on the other side with the foot when releasing the lock, so it is not necessary to lift the pedal by the foot.

In the present disclosure, the first brake mechanism 1 is arranged on the first rear wheel 101, the second brake mechanism 2 is arranged on the second rear wheel 102, and the first brake mechanism 1 and the second brake mechanism 2 are connected by a traction element 3, so that the second brake mechanism 2 may be driven to lock the second rear wheel 102 when the first brake mechanism 1 locks the first rear wheel 101, or the first brake mechanism 1 is driven to unlock the first rear wheel 101 when the second brake mechanism 2 unlocks the second rear wheel 102, thereby achieving the effect that the two rear wheels are simultaneously stopped by stepping down at one side to lock the rear wheels, and the two rear wheels are simultaneously unlocked by stepping down at the other side. Therefore, the operation is simple and convenient, and it is not necessary to lift the pedal by the foot, thereby ensuring that the vamp of the user is clean.

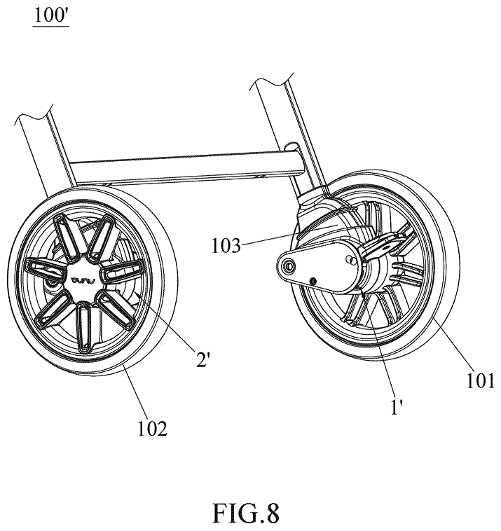

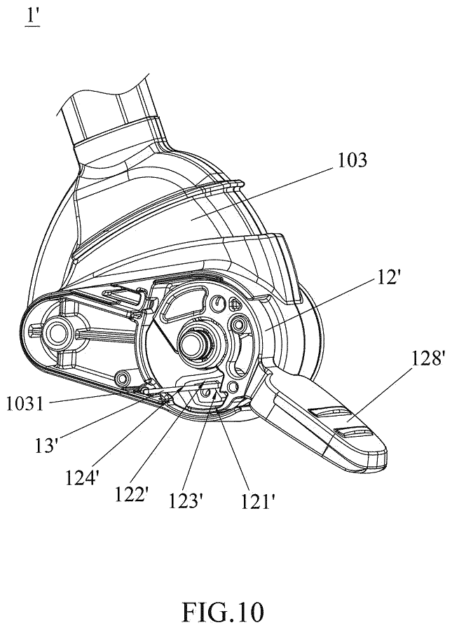

As shown in FIGS. 8 to 12, a structure of the brake device 100′ for a wheel set of a baby carrier according to a second embodiment of the present disclosure is shown.

Referring to FIGS. 8 to 10, the brake device 100′ in this embodiment includes a first brake mechanism 1′, a second brake mechanism 2′ and a traction element 3′. The first brake mechanism 1′ is arranged on the first rear wheel seat 103 of the frame of the baby carriage for locking or unlocking the first rear wheel 101, and the second brake mechanism 2′ is arranged on the second rear wheel seat 104 of the frame of the baby carriage for locking or unlocking the second rear wheel 102. The traction element 3′ is connected between the first brake mechanism 1′ and the second brake mechanism 2′ to interlink the first brake mechanism 1′ and the second brake mechanism 2′ with each other when locking or unlocking. The second brake mechanism 2′ is driven to lock the second rear wheel 102 when the first brake mechanism 1′ locks the first rear wheel 101, and the second brake mechanism 2′ is driven to unlock the second rear wheel 102 when the first brake mechanism 1′ unlocks the first rear wheel 101. An operating direction of the first brake mechanism 1′ during locking is the same as an operating direction of the first brake mechanism 1′ during unlocking.

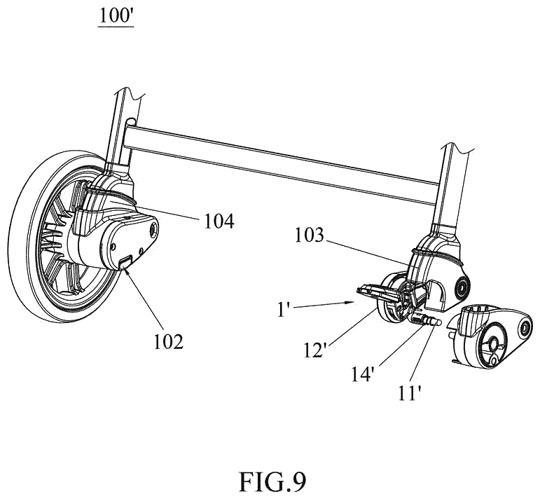

As shown in FIGS. 9 to 12, the first brake mechanism 1′ includes a first shaft pin 11′, a first driver 12′ for driving the first shaft pin 11′ and an engaging hook 13′. The first shaft pin 11′ is configured to lock or unlock the first rear wheel 101, and the second brake mechanism 2′ includes a second shaft pin and a second driver for driving the second shaft pin. The second shaft pin and the second driver for driving the second shaft pin in this embodiment have the same structure as the first shaft pin 11 and the first driver 12 in the first embodiment, and thus will not be repeated herein. The second shaft pin is configured to lock or unlock the second rear wheel 102, and the traction element 3′ is connected between the first driver 12′ and the second driver. The first driver 12′ is provided with a first guide groove 121′ and a second guide groove 122′. An engaging position 123′ and an unlocking position 124′ are provided between the first guide groove 121′ and the second guide groove 122′. The first driver 12′ is also provided with a third guide groove 125′ and a fourth guide groove 126′. Both ends of the third guide groove 125′ are connected with the first guide groove 121′ and the engaging position 123′, and both ends of the fourth guide groove 126′ are connected with the engaging position 123′ and the second guide groove 122′. The first guide groove 121′, the third guide groove 125′, the engaging position 123′, the fourth guide groove 126′, the second guide groove 122′ and the unlocking position 124′ are sequentially connected to form a closed loop. A V-shaped structure is formed between the third guide groove 125′, the engaging position 123′ and the fourth guide groove 126′ to prevent the engaging hook 13′ from accidentally disengaging from the engaging position 123′. An end of the engaging hook 13′ is fixed on the first rear wheel seat 103 of the baby carriage, and the other end of the engaging hook 13′ slidably passes through the first guide groove 121′, the third guide groove 125′, the engaging position 123′, the fourth guide groove 126′, the second guide groove 122′ and the unlocking position 124′ in sequence. When the first driver 12′ rotates and pushes the first shaft pin 11′ to lock the first rear wheel 101, the engaging hook 13′ slides from the first guide groove 121′ to the engaging position 123′, and when the first driver 12′ rotates and pushes the first shaft pin 11′ to unlock the first rear wheel 101, the engaging hook 13′ slides from the engaging position 123′ to the unlocking position 124′. In addition, a fixing hole 1031 is provided on the first rear wheel seat 103 of the frame of the baby carriage, and an end of the engaging hook 13′ is bent and inserted into the fixing hole 1031. The fixing hole 1031 may limit an end of the engaging hook 13′, and also ensure that the engaging hook 13′ may be rotated for a certain angle when sliding in the guide grooves, thereby enhancing the flexibility of the engaging hook 13′ and avoiding the deformation of the engaging hook 13′.

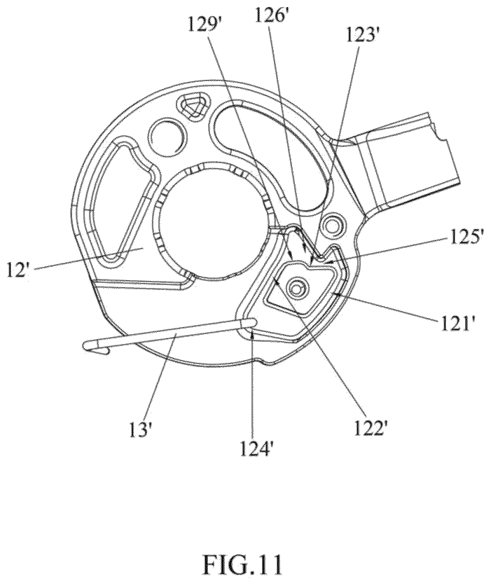

In addition, as shown in FIG. 11, a guide slope 129′ is provided between the fourth guide groove 126′ and the second guide groove 122′, and allows the engaging hook 13′ to slide towards the second guide groove 122′. Since the engaging hook 13′ may be deformed when the engaging hook 13′ slides upward on the fourth guide groove 126′ to perform the unlocking, and a groove wall of the fourth guide groove 126′ is crushed, the engaging hook 13′ may automatically and quickly slide into the second guide groove 122′ by providing the guide slope 129′, thereby avoiding the engaging hook 13′ from being deformed and preventing the groove wall of the fourth guide groove from being crushed, and prolonging the service life.

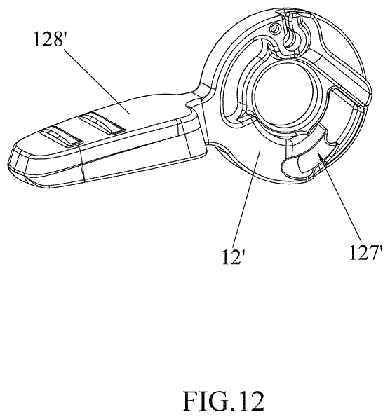

Referring to FIGS. 9 and 12, and in an embodiment, the first brake mechanism 1′ also includes a first elastic element 14′, which is a compression spring. The first elastic element 14′ is arranged in the first rear wheel seat 103 and sleeved with the first shaft pin 11′. The first driver 12′ is provided with a first driving slope 127′ at a side, and the first shaft pin 11′ is slidably arranged on the first rear wheel seat 103, so as to be inserted into the first rear wheel 101 by pushing of the first driving slope 127′ when the first driver 12′ is rotated, or to be withdrawn from the first rear wheel 101 under the elastic force of the first elastic element 14′. The first driving slope 127′ of this embodiment also has a structure similar to that in the first embodiment, i.e., having the locking position 122 at an end of the first driving slope 121 and the unlocking position 123 at the other end of the first driving slope 121, so as to position the first shaft pin 11′, which will not be repeated herein. The first driver 12′ is also provided with an operating member (e.g., pedal 128′) for being stepped down.

The second brake mechanism 2′ also includes a second elastic element and a third elastic element. The specific structure of the second brake mechanism 2′ of the second embodiment is not shown in the attached drawings, but its structure and principle are the same as those of the first embodiment as shown in the drawings. The third elastic element is arranged in the second rear wheel seat 104 and may provide an elastic force to rotate and reset the second driver. The second elastic element is a compression spring and is sleeved on the second shaft pin. The second driver is provided with a second driving slope at a side, and the second shaft pin is slidably arranged on the second rear wheel seat 104, so as to be inserted into the second rear wheel 102 by pushing of the second driving slope when the second driver is rotated, or to be withdrawn from the second rear wheel 102 under the elastic force of the second elastic element. In an embodiment, a locking position is provided at an end of the second driving slope, and an unlocking position 124′ is provided at the other end. When the second driver is placed horizontally, the locking position is located at a high position of the second driver, and the unlocking position 124′ is located at a low position of the second driver. When an end of the second shaft pin is inserted into the second rear wheel 102, the other end of the second shaft pin is located in the locking position, and when an end of the second shaft pin is withdrawn from the second rear wheel 102, the other end of the second shaft pin is located in the unlocking position 124′.

Based on the above and with reference to FIGS. 8 to 12, the working principle of the brake device 100′ for the wheel set of the baby carriage of this embodiment will be described in detail as follows.

When it is necessary to perform the braking, a pedal on the first driver 12′ is stepped down by the foot, and the first driver 12′ is rotated. At this time, the engaging hook 13′ slides from the first guide groove 121′ to the third guide groove 125′, and then from the third guide groove 125′ to the engaging position 123′. In this process, the first driving slope 127′ and the first shaft pin 11 relatively slide, and the first shaft pin 11′ slides from the unlocking position 124′ to the locking position along the first driving slope 127′. At the same time, the first driving slope 127′ drives the first shaft pin 11′ to be inserted into the first rear wheel 101, thereby stopping the first rear wheel 101. In addition, the first driver 12′ pulls the traction element 3′ while the first driver 12′ is rotated, and the traction element 3′ drives the second driver to rotate. The second driving slope of the second driver drives the second shaft pin to be inserted into the second rear wheel 102, and the second shaft pin slides from the unlocking position 124′ to the locking position along the second driving slope. At this time, the first rear wheel 101 and the second rear wheel 102 are simultaneously locked.

When it is necessary to perform the unlocking, the pedal on the first driver 12′ is stepped down by the foot again, and the first driver 12′ is rotated. At this time, the engaging hook 13′ is withdrawn from the engaging position 123′ and slides to the fourth guide groove 126′, and then the engaging hook 13′ enters the guide slope 129′ from the fourth guide groove 126′. The engaging hook 13′ slides to the second guide groove 122′ under the guide of the guide slope 129′, and then slides from the second guide groove 122′ to the unlocking position 124′. In this process, the first driver 12′ drives the first driving slope 127′ to rotate, and under the elastic force of the first elastic element 14′, the first shaft pin 11′ slides from the locking position to the unlocking position 124′. The other end of the first shaft pin 11′ is withdrawn from the first rear wheel 101. At the same time, the first driver 12′ drives the second driver to rotate through the traction element 3′, the second driver drives the second driving slope to rotate, and under the elastic force of the second elastic element, the second shaft pin slides from the locking position to the unlocking position 124′. The other end of the second shaft pin is withdrawn from the second rear wheel 102. At this time, the first rear wheel 101 and the second rear wheel 102 are simultaneously unlocked.

In brief, the operation direction of stepping down the operating member (i.e. the pedal 128′) on the first driver 12′ with the foot when braking is the same as that of stepping down the pedal 128′ with the foot again when releasing the lock, so it is not necessary to lift the pedal by the foot.

The first brake mechanism 1′ is arranged on the first rear wheel 101, the second brake mechanism 2′ is arranged on the second rear wheel 102, and the first brake mechanism 1′ and the second brake mechanism 2′ are connected by a traction element 3′, so that the second brake mechanism 2′ may be driven to lock the second rear wheel 102 when the first brake mechanism 1′ locks the first rear wheel 101, or the second brake mechanism 2′ may be driven to unlock the second rear wheel 102 when the first brake mechanism 1′ unlocks the first rear wheel 101, thereby achieving the effect that the two rear wheels are simultaneously stopped by stepping down at one (same) side to lock or unlock the rear wheels. Therefore, the operation is simple and convenient, and it is not necessary to lift the pedal by the foot, thereby ensuring that the vamp of the user is clean.

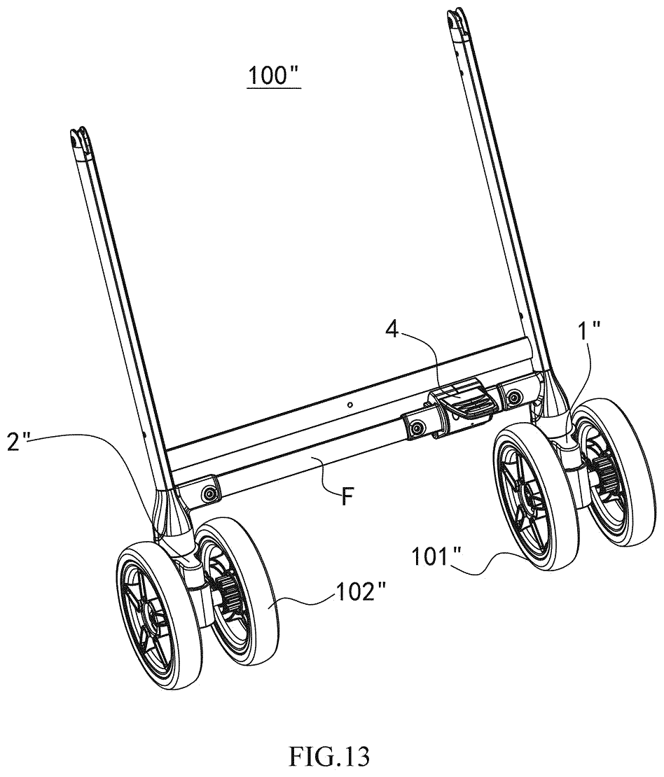

FIGS. 13-34 schematically show a structure of a brake device 100″ of the wheel set of the baby carriage according to the third embodiment of the present disclosure.

The brake device 100″ includes a first brake mechanism 1″, a second brake mechanism 2″ and a traction element 3″. The first brake mechanism 1″ is arranged on a first wheel 101″ of the baby carriage for locking or unlocking the first wheel 101″, and the second brake mechanism 2″ is arranged on a second wheel 102″ of the baby carriage for locking or unlocking the second wheel 102″. The traction element 3″ is connected between the first brake mechanism 1″ and the second brake mechanism 2″ so that the first brake mechanism 1″ and the second brake mechanism 2″ interact with each other when locking or unlocking.

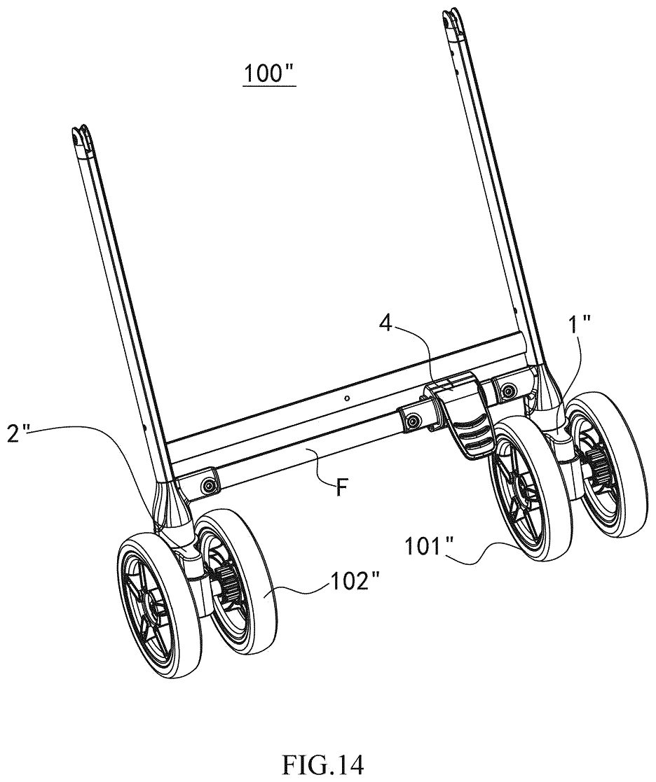

As shown in FIGS. 13 and 14, the brake device 100″ for the wheel set of the baby carriage also includes a driving mechanism 4 arranged on a frame F of the baby carriage. The driving mechanism 4 is connected to the first brake mechanism 1″ and the second brake mechanism 2″ through a traction element 3″ (not shown), and the driving mechanism 4 may be operated in one direction so as to simultaneously drive the first brake mechanism 1″ and the second brake mechanism 2″ through the traction element 3″ to lock the first wheel 101″ and the second wheel 102″, respectively. Then, the driving mechanism 4 may be operated again in one direction, so as to simultaneously drive the first brake mechanism 1″ and the second brake mechanism 2″ through the traction element 3″ to unlock the first wheel 101″ and the second wheel 102″ respectively.

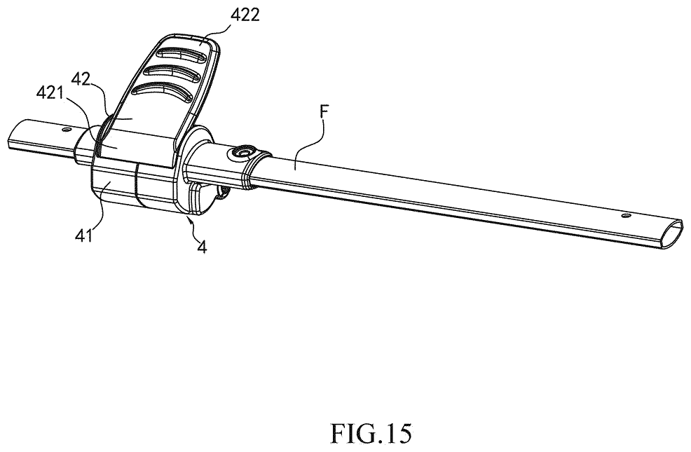

Next, referring to FIGS. 15 to 29, a combined structure in which the driving mechanism 4 is operated twice in the same direction according to the third embodiment of the present disclosure will be described.

As shown in FIG. 15, the driving mechanism 4 includes: a fixed seat 41 fixed on the frame F of the baby carriage; a third driver 42 having a body portion 421 rotatably arranged in the fixed seat 41, so that the third driver 42 may pivot around a central axis of the frame F. The body portion 421 extends out of the third operating member 422 for the user to operate, such as a pedal or an operating lever. In the embodiment shown in FIGS. 13 and 14, the frame F may be a connecting rod between the first wheel 101″ and the second wheel 102″ (for example, a transverse tube between two rear leg tubes), and the fixed seat 41 is fixed to the connecting rod.

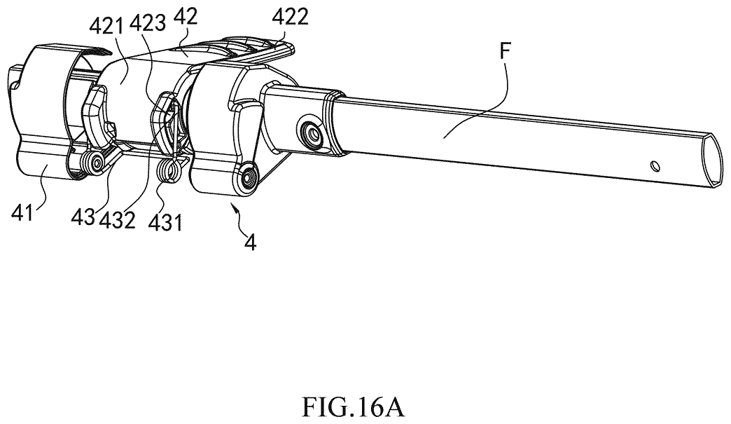

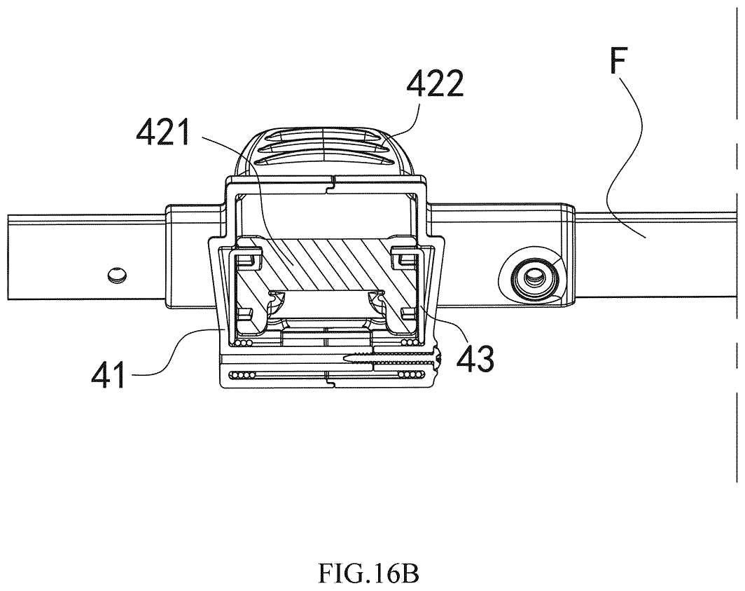

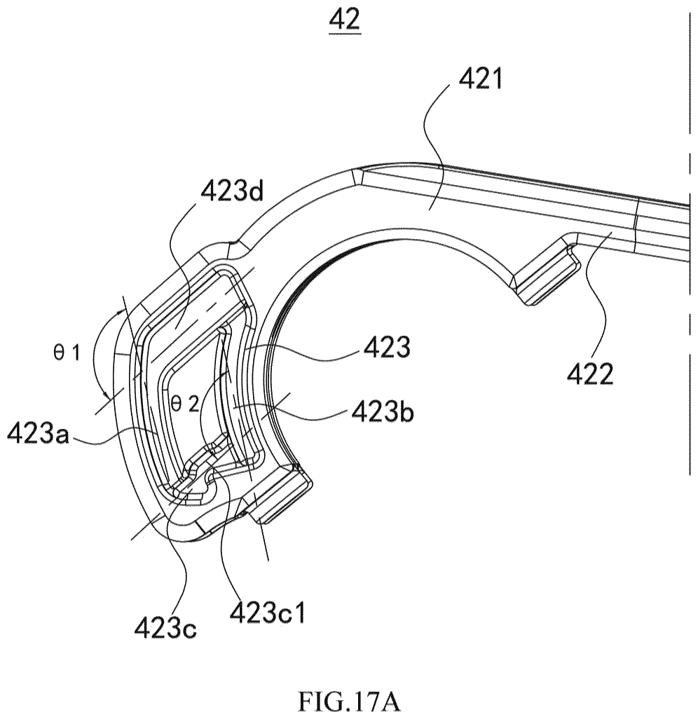

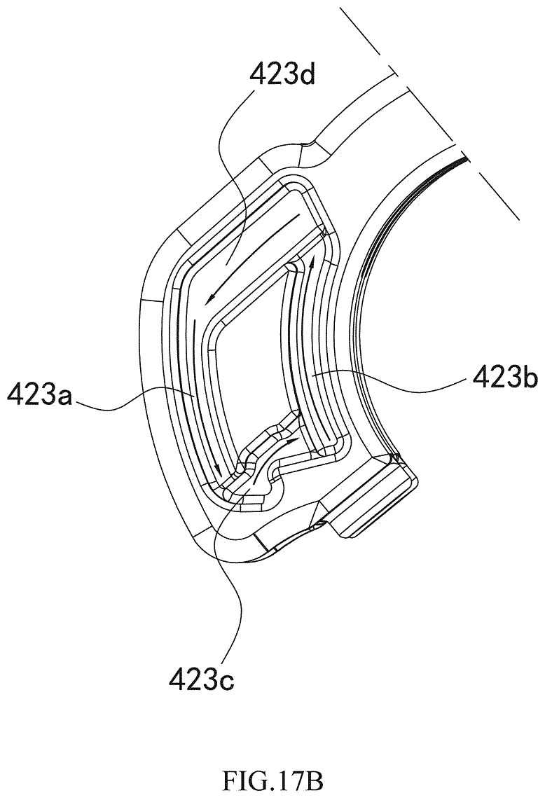

As shown in FIG. 16A, the body portion 421 of the third driver 42 includes a guide side surface 423. As shown in FIG. 17, the guide side surface 423 includes a first guide groove 423a and a second guide groove 423b, and an engaging groove 423c and an unlocking groove 423d are provided between the first guide groove 423a and the second guide groove 423b. The first guide groove 423a, the engaging groove 423c, the second guide groove 423b and the unlocking groove 423d are sequentially connected into a closed annular groove.

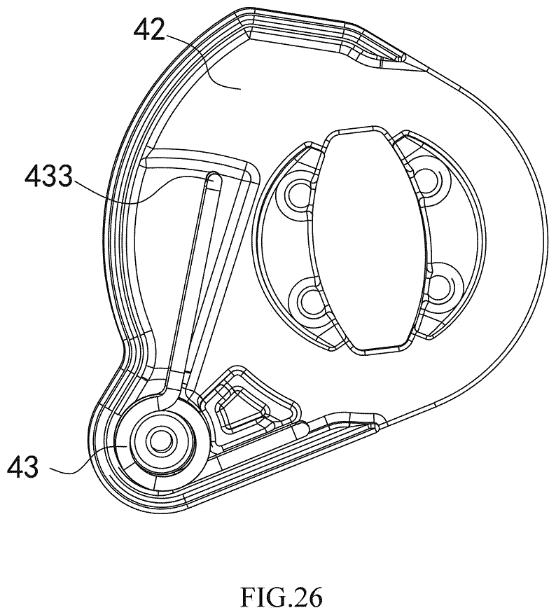

In addition, the other side of the body portion 421 of the third driver 42 opposite to the guide side surface 423 may be provided with a same guide side surface, or no guide side surface may be provided as shown in FIG. 26.

As shown in FIGS. 16A and 16B, the driving mechanism 4 further includes an engaging torsion spring 43, and the engaging torsion spring 43 includes a fixed portion 431 and a torsion spring head 432 extending from the fixed portion 431. The fixed portion 431 is fixed on the fixed seat 41, and the torsion spring head 432 is slidably arranged in an annular groove of the guide side surface 423. When the third driver 42 pivots around the central axis of the frame F, the torsion spring head 432 will sequentially slide through the first guide groove 423a, the engaging groove 423c, the second guide groove 423b and the unlocking groove 423d in a counterclockwise direction starting from the unlocking groove 423d.

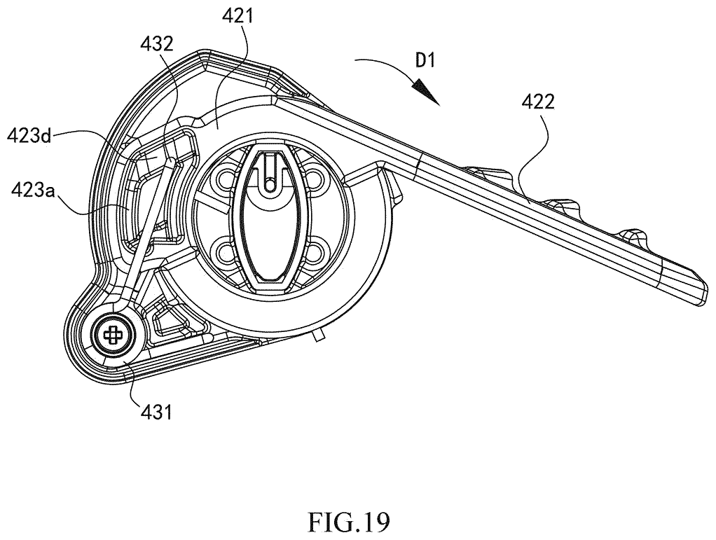

In order to ensure that the torsion spring head 432 slides in the annular groove of the guide side surface 423 in the counterclockwise direction, in an embodiment, an angle θ1 between the first guide groove 423a and the unlocking groove 423d is greater than 90 degrees, and an angle θ2 between the second guide groove 423b and the engaging groove 423c is greater than 90 degrees, so that when the third driver 42 pivots in the first direction D1 (as shown in FIG. 19), the torsion spring head 432 are more prone to sliding from the unlocking groove 423d to the first guide groove 423a, and when the third driver 42 pivots again in the first direction D, the torsion spring head 432 is more prone to sliding from the engaging groove 423c to the second guide groove 423b. Here, the angle between the two grooves refers to an angle between substantially extending directions of the two grooves.

In yet another embodiment as shown in FIG. 17B, a bottom surface of at least one of the first guide groove 423a, the engaging groove 423c, the second guide groove 423b and the unlocking groove 423d is provided to gradually become higher from an end of the groove to the other end in the counterclockwise direction as indicated by an arrow in FIG. 17B, so that a step structure may be formed between the bottom surfaces of at least adjacent two of the first guide groove 423a, the engaging groove 423c, the second guide groove 423b and the unlocking groove 423d, thereby ensuring that the torsion spring head 432 does not accidentally slide in the annular groove of the guide side surface 423 in an opposite direction.

In an aspect, the bottom surface of each of these four grooves may be provided to gradually increase from an end of the groove to the other end in the counterclockwise direction indicated by the arrows in FIG. 17B, and a step structure is formed between the bottom surfaces of any two adjacent grooves, so that the bottom surface of the first guide groove 423a is higher than the bottom surface of the engaging groove 423c at the connection of the first guide groove 423a and the engaging groove 423c; the bottom surface of the engaging groove 423c is higher than the bottom surface of the second guide groove 423b at the connection of the engaging groove 423c and the second guide groove 423b; the bottom surface of the second guide groove 423b is higher than the bottom surface of the unlocking groove 423d at the connection of the second guide groove 423b and the unlocking groove 423d; and the bottom surface of the unlocking groove 423d is higher than the bottom surface of the first guide groove 423a at the connection of the unlocking groove 423d and the first guide groove 423a.

In another aspect, the bottom surface of one of the grooves, such as the bottom surface of the engaging groove 423c, may be provided to have a constant height from an end of the groove to the other end, while the bottom surfaces of the other three grooves are provided to gradually become higher from an end of the groove to the other end in the counterclockwise direction indicated by the arrows in FIG. 17B.

In yet another aspect, the bottom surface of each of the four grooves is provided to gradually become higher from an end of the groove to the other end in the counterclockwise direction indicated by the arrows in FIG. 17B, no step structure is formed between the bottom surfaces of two adjacent grooves, for example, the bottom surfaces of the unlocking groove 423d and the first guide groove 423a, while a step structure is formed between the bottom surfaces of other adjacent grooves.

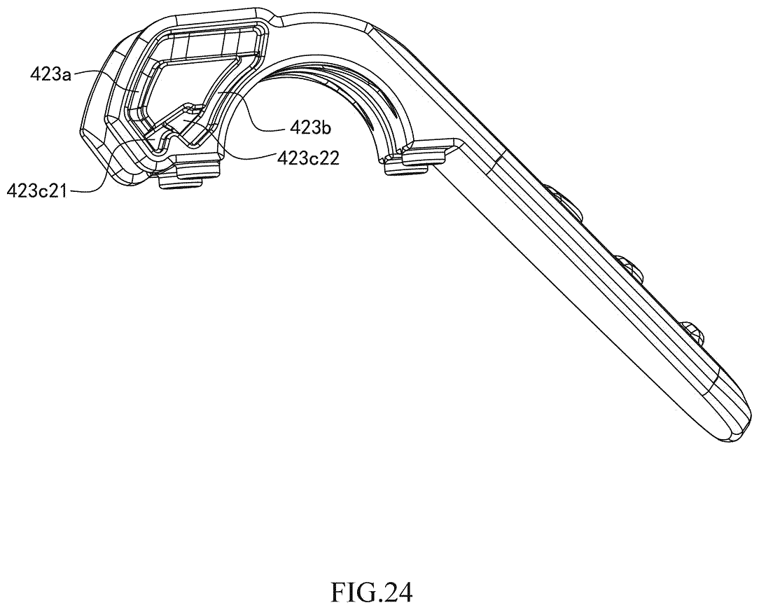

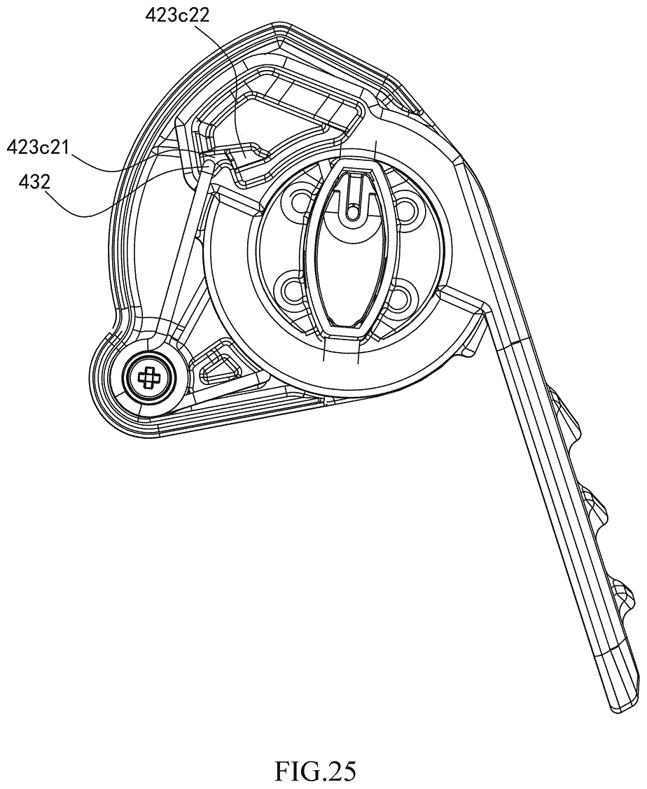

Furthermore, as shown in FIGS. 24 and 25, the engaging groove 423c is divided into two sections 423c21 and 423c22 along an extending direction of the annular groove, a stepped structure is formed between bottom surfaces of these two sections, and the bottom surface of the section 423c21 close to the first guide groove 423a is higher than the bottom surface of the section 423c22 close to the second guide groove 423b, thereby ensuring that the torsion spring head 432 can be smoothly engaged in the engaging groove.

In addition, the engaging torsion spring 43 may include a fixed torsion spring head 433 (see FIG. 26) extending out of the fixed portion 431, and the fixed torsion spring head 433 may be arranged on the other side of the body portion 421 of the third driver 42 opposite to the guide side surface 423, as shown in FIG. 26, for better fixing the engaging torsion spring 43.

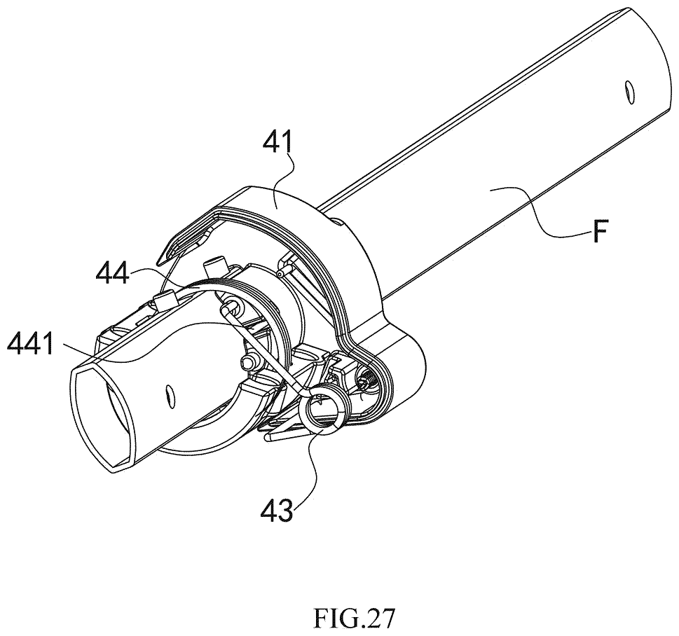

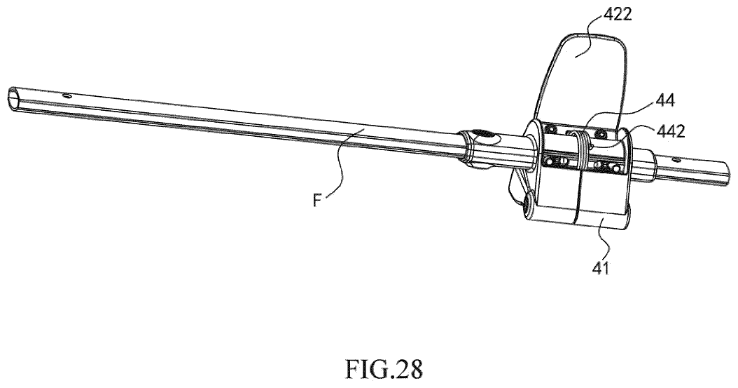

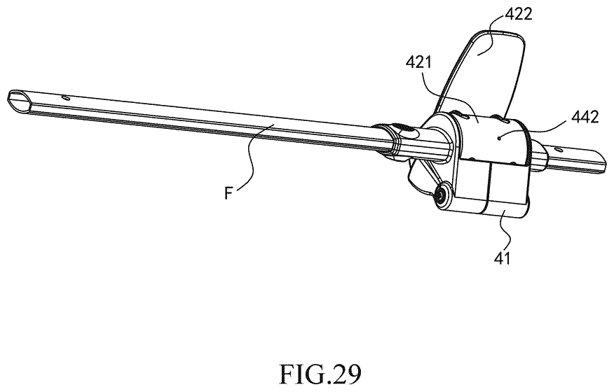

As shown in FIGS. 27 to 29, the driving mechanism 4 further includes a return torsion spring 44 having a first end 441 fixed to the fixed seat 41, as shown in FIGS. 27-28, and a second end 442 fixed to the body portion 421 of the third driver 42. For example, the second end 442 may be fixed to a bottom through hole of the body portion 421, as shown in FIG. 29. The return torsion spring 44 is configured to drive the third driver 42 to return to the initial position.

Next, a working condition that the driving mechanism 4 is operated twice in the same operating direction according to the third embodiment of the present disclosure will be described.

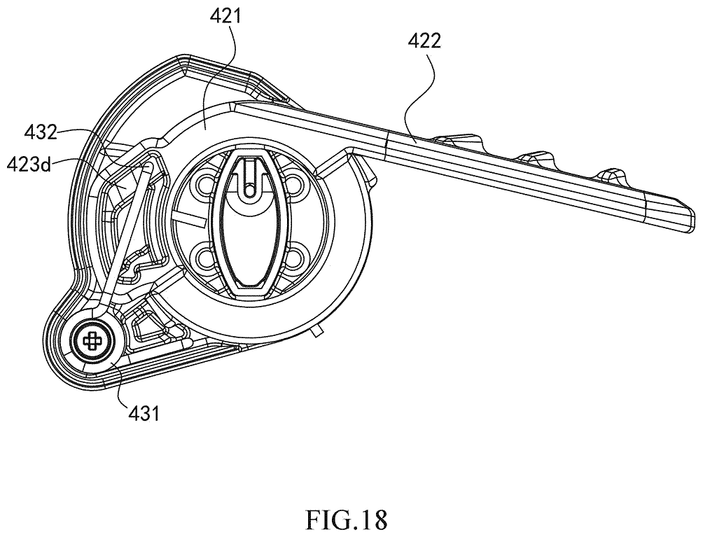

As shown in FIG. 18, when the third driver 42 is in the initial position, the torsion spring head 432 is located in the unlocking groove 423d.

When the driving mechanism 4 is operated by the user in one direction, for example, when the user applies a downward pressure to the third operating member 422 of the third driver 42, the third driver 42 pivots in the first direction D1 against an elastic force of the return torsion spring 44, and the torsion spring head 432 slides along the unlocking groove 423d to the first guide groove 423a, as shown in FIG. 19.

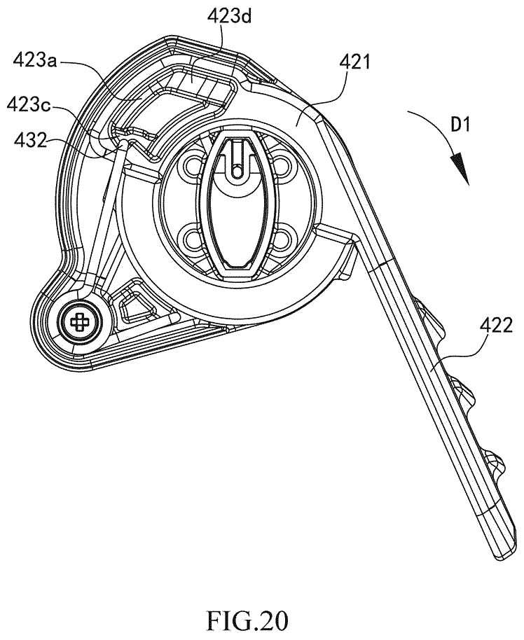

As the third driver 42 continues to pivot in the first direction D1, the torsion spring head 432 slides along the first guide groove 423a to the engaging groove 423c. At this time, the torsion spring head 432 hooks an outer side wall of the engaging groove 423c, as shown in FIG. 20, so that the third driver 42 cannot continue to pivot in the first direction D1, that is, the third driver 42 pivots to the end position in the first direction D1. In this process, the driving mechanism 4 simultaneously drives the first brake mechanism 1″ and the second brake mechanism 2″ through the traction element 3″ to lock the first wheel 101″ and the second wheel 102″. The outer side wall of the engaging groove 423c refers to a side wall away from a center of the annular groove, and an inner side wall of the engaging groove 423c hereinafter refers to a side wall close to the center of the annular groove.

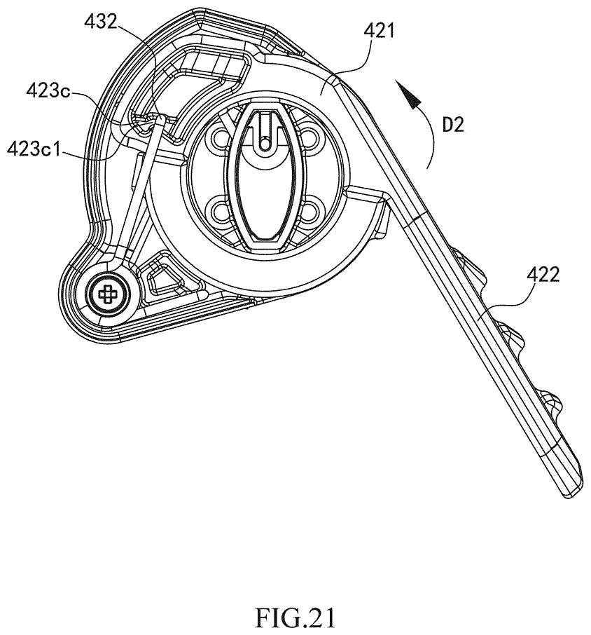

When the user no longer exerts the downward pressure on the third operating member 422 of the third driver 42, the third driver 42 pivots in the second direction D2 under the elastic force of the return torsion spring 44, so that the torsion spring head 432 leaves the outer side wall of the engaging groove 423c and then abut against the inner side wall of the engaging groove 423c, and the third driver 42 is unable to continue to pivot in the second direction D2, thereby keeping the third driver 42 in the locking portion. In this process, a stroke of the third driver 42 pivoting in the second direction D2 is very short, so that the first brake mechanism 1″ and the second brake mechanism 2″ keep the first wheel 101″ and the second wheel 102″ to be locked. In order to ensure that the torsion spring head 432 abuts against the inner side wall of the engaging groove 423c without accidental disengagement, the inner side wall of the engaging groove 423c may include a recess 423c1 for the torsion spring head 432 to be positioned, and the included angle of the recess 423c1 is greater than 90 degrees, as shown in FIG. 21. The included angle of the recess refers to the included angle between the two inner side walls of the engaging groove 423c that constitute the recess.

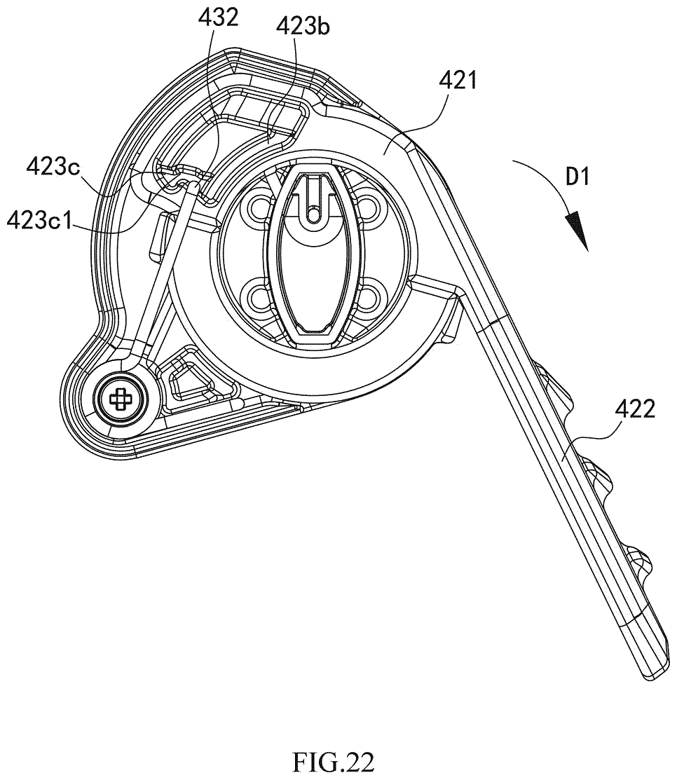

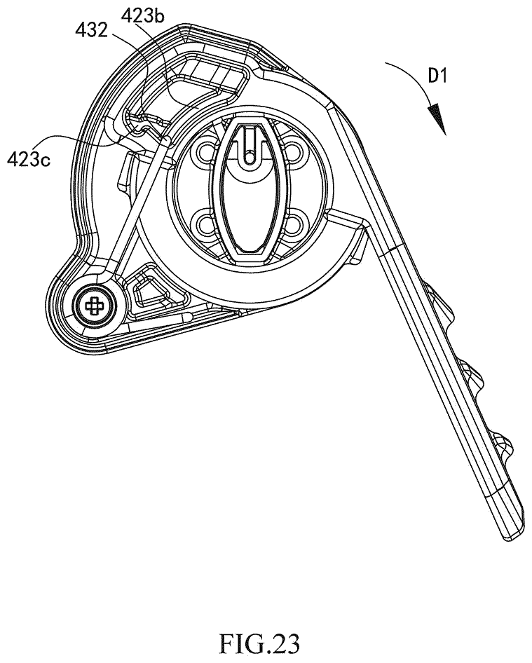

When the driving mechanism 4 is operated again by the user in the same direction, for example, when the user applies a downward pressure to the third operating member 422 of the third driver 42 again, the third driver 42 pivots again in the first direction D1 against the elastic force of the return torsion spring 44, and the torsion spring head 432 leaves the inner side wall of the engaging groove 423c and reach the outer side wall, as shown in FIG. 22. As the third driver 42 continues to pivot in the first direction D1, the torsion spring head 432 slides along the engaging groove 423c to the second guide groove 423b until the torsion spring head 432 slides to the second guide groove 423b and hooks an end wall of the second guide groove 423b, as shown in FIG. 23, so that the third driver 42 is unable to continue to pivot in the first direction D1. In this process, the stroke of the third driver 42 pivoting in the first direction D1 is also very short, so that the first brake mechanism 1″ and the second brake mechanism 2″ keep the first wheel 101″ and the second wheel 102″ to be locked.

When the user no longer exerts the downward pressure on the third operating member 422 of the third driver 42, the third driver 42 pivots in the second direction D2 under the elastic force of the return torsion spring 44, the torsion spring head 432 slides along the second guide groove 423b to the unlocking groove 423d, and the third driver 42 returns to the initial position, as shown in FIG. 18. In this process, the driving mechanism 4 simultaneously drives the first brake mechanism 1″ and the second brake mechanism 2″ through the traction element 3″ to unlock the first wheel 101″ and the second wheel 102″.

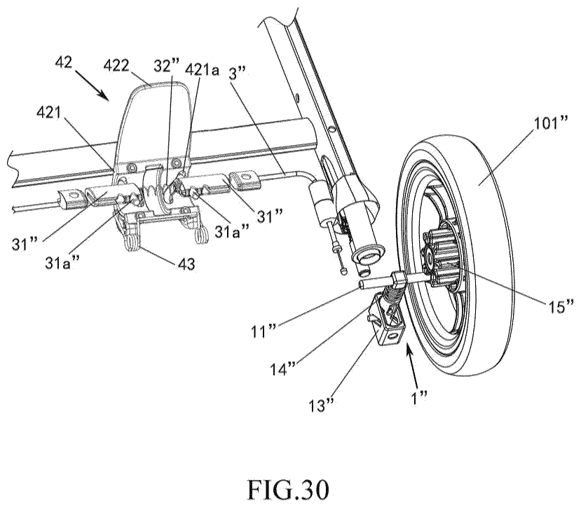

Next, with reference to FIGS. 30 to 32, an embodiment about how the driving mechanism 4 simultaneously drives the first brake mechanism 1″ and the second brake mechanism 2″ through the traction member 3″ according to the third embodiment of the present disclosure will be described.

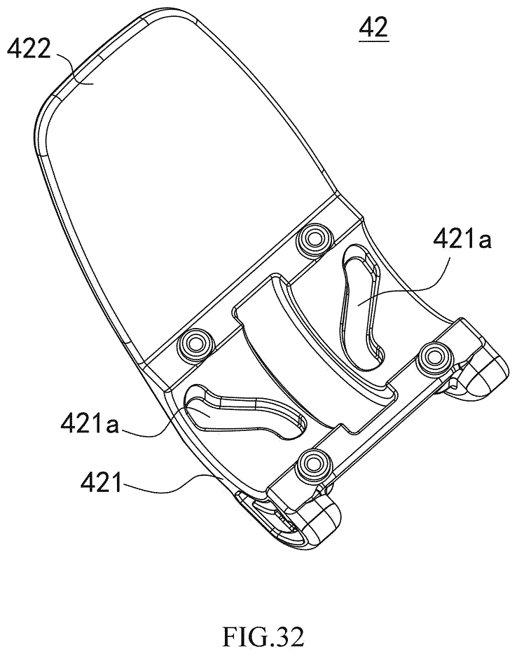

As shown in FIG. 32, an inner side surface of the body portion 421 of the third driver 42 is symmetrically provided with a pair of driving chutes 421a, and a distance between ends of the pair of driving chutes 421a at the same side is smaller than a distance between the other ends.

In the third embodiment of the present invention, the driving mechanism 4 can be connected with the traction element 3″ corresponding to the first brake mechanism 1″ in the same way as the driving mechanism 4 can be connected with the traction element 3″ corresponding to the second brake mechanism 2″, so only the driving mechanism 4 being connected with the traction element 3″ corresponding to the first brake mechanism 1″ will be described here as an example.

As shown in FIG. 30, an end of the traction member 3″ connected to the driving mechanism 4 is connected with a driving pin 31″. The driving pin 31″ is axially slidably arranged in a bearing section of the frame F bearing the driving mechanism 4 along the central axis of the frame F, and includes a sliding shaft 31a″ perpendicular to its own central axis. The bearing section of the frame F is provided with an elongated hole extending along a direction of the central axis of the frame F. The sliding shaft 31a″ is slidably inserted into the elongated hole and inserted into the driving chute 421a, so as to drive the driving pin 31″ to slide through the driving chute 41a when the third driver 42 pivots. The drive chute 421a may be provided so that a torsional force pivoting the third driver 42 may be converted into an axial pulling force on the driving pin 31″, so that the driving pin 31″ may pull the traction member 3″ and then the first brake mechanism 1″ through the traction member 3″ to lock the first wheel 101″. The third driver 42 may simultaneously drive the two driving pins 31″ to slide, thereby simultaneously driving the first brake mechanism 1″ and the second brake mechanism 2″.

However, the present disclosure is not limited thereto. The driving mechanism 4 may adopt other embodiments to simultaneously drive the first brake mechanism 1″ and the second brake mechanism 2″ through the traction element 3″.

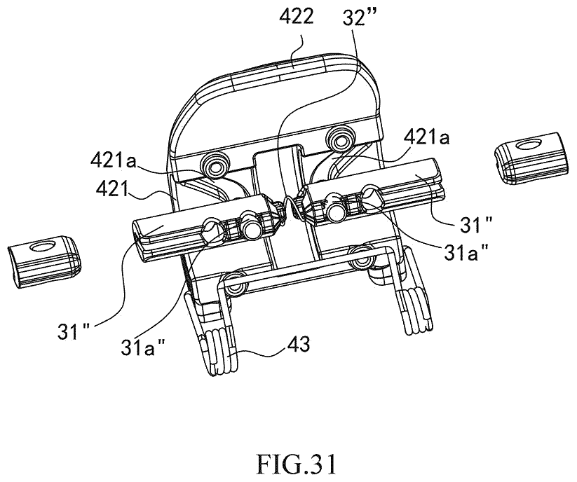

As shown in FIG. 31, an elastic element 32″ is connected between the two driving pins 31″. The elastic element 32″ may provide an elastic force for the elastic element 32″ of the driving pin to reset, so that the elastic element 32″ can realize repeated actions. For example, the elastic element 32″ may be a compression spring. When the two driving pins 31″ are driven by the third driver 42 to approach each other, the elastic element 32″ is compressed.

Next, referring to FIGS. 30, 33 and 34, an embodiment about how the first brake mechanism 1″ and the second brake mechanism 2″ lock or unlock the first wheel 101″ and the second wheel 102″ driven by the traction member 3″ according to the third embodiment of the present disclosure will be described.

In this embodiment, the first brake mechanism 1″ and the second brake mechanism 2″ may adopt the same structure, so only the first brake mechanism 1″ will be described herein as an example.

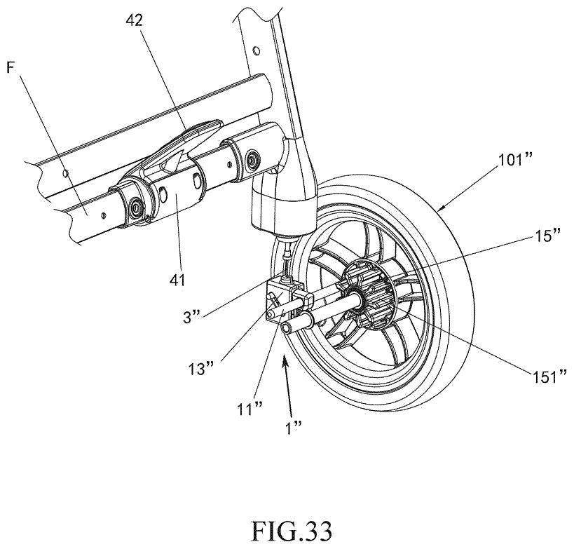

As shown in FIGS. 30 and 33, the first brake mechanism 1″ includes a locking member 11″, a sliding sleeve 13″, an elastic return element 14″ and a locking groove structure 15″ with a plurality of locking grooves 151″ arranged in a circumferential direction at an axle of the first wheel 101″.

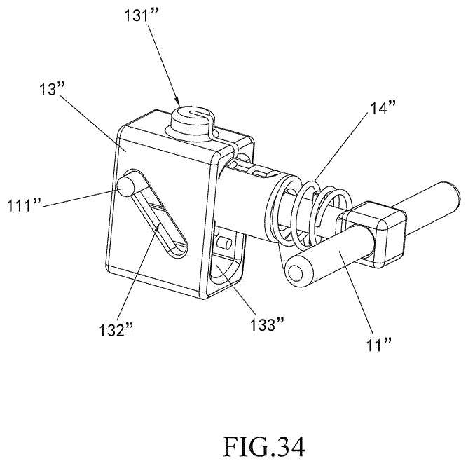

As shown in FIG. 34, the sliding sleeve 13″ is a hollow structure with a lateral opening, and has a traction portion 131″ at a top wall thereof for connecting with the traction element 3″ and a through chute 132″ at a side wall thereof for driving the locking member 11″.

The locking member 11″ includes a first shaft and a second shaft which form a T-shaped structure. The first shaft is arranged in the sliding sleeve 13″ and may extend or retract the sliding sleeve 13″. An end of the first shaft in the sliding sleeve 13″ includes a sliding pin 111″ which passes through the through chute 132″ on the side wall of the sliding sleeve 13″, so that when the sliding sleeve 13″ is pulled by the traction member 3″ to move upwards, the through chute 132″ drives the sliding pin 111″ to move transversely, and thus the first shaft of the locking member 11″ at least partially extending out of the sliding sleeve 13″. The second shaft engages with one of the locking grooves 151″ in the locking groove structure 15″ as the first shaft extends out of the sliding sleeve 13″, so that the first wheel 101″ is locked.

The elastic return element 14″ is located between the locking member 11″ and the sliding sleeve 13″ to provide an elastic force to retract the first shaft of the locking member 11″ into the sliding sleeve 13″. The elastic return element 14″ may be a tension spring or a elastic belt, for example. When the first shaft of the locking member 11″ extends out of the sliding sleeve 13″, the elastic return element 14″ is pressed. Once the sliding sleeve 13″ is no longer pulled by the traction member 3″, the first shaft of the locking member 11″ returns to the sliding sleeve 13″ under the action of the elastic return element 14″, and the second shaft disengages from the locking groove 151″ in the locking groove structure 15″ as the first shaft returns to the sliding sleeve 13″, so that the first wheel 101″ is unlocked. At the same time, the sliding pin 111″ on the first shaft in turn drives the through chute 132″, causing the sliding sleeve 13″ to move downward.

It should be understood that the first brake mechanism 1″ and the second brake mechanism 2″ of the third embodiment of the present disclosure are not limited to the above-mentioned embodiments, and they may also adopt the structure of the second brake mechanism of the second embodiment of the present disclosure.

The contents disclosed above are only preferred examples of the present disclosure, and cannot limit the scope of the present disclosure. Therefore, equivalent changes made according to the scope of the present disclosure still fall within the scope of the present disclosure.

1. A brake device for a wheel set of a baby carriage comprising:
a first brake mechanism arranged on a first wheel of the baby carriage for locking or unlocking the first wheel;
a second brake mechanism arranged on a second wheel of the baby carriage for locking or unlocking the second wheel; and
a traction element connected between the first brake mechanism and the second brake mechanism, so that the first brake mechanism and the second brake mechanism are mutually linked when locking or unlocking, and an operating direction during locking is same as an operating direction during unlocking.

2. The brake device according to claim 1, wherein when the first brake mechanism locks the first wheel, the first brake mechanism drives the second brake mechanism to lock the second wheel through the traction element, and when the second brake mechanism unlocks the second wheel, the second brake mechanism drives the first brake mechanism to unlock the first wheel through the traction element.

3. The brake device according to claim 1, wherein the first brake mechanism comprises a first shaft pin locking or unlocking the first wheel, and the second brake mechanism comprises a second shaft pin locking or unlocking the second wheel.

4. The brake device according to claim 3, wherein the first brake mechanism further comprises a first driver for driving the first shaft pin, the second brake mechanism further comprises a second driver for driving the second shaft pin, and the traction element is connected between the first driver and the second driver.

5. The brake device according to claim 4, wherein the first driver is rotatably arranged and provided with a first driving slope at a side, the first brake mechanism further comprises a first elastic element, and the first shaft pin is slidably arranged, so as to be inserted into the first wheel by pushing of the first driving slope when the first driver is rotated, or to be withdrawn from the first wheel under an elastic force of the first elastic element.

6. The brake device according to claim 5, wherein the first driving slope is provided with a locking position at an end thereof and a locking release position at the other end.

7. The brake device according to claim 5, wherein the first driver is provided with an arc-shaped guide hole for guiding its rotation.

8. The brake device according to claim 5, wherein the first driver is provided with a first operating member for driving the first driver to rotate.

9. The brake device according to claim 4, wherein the second driver is rotatably arranged and provided with a second driving slope at a side, the second brake mechanism further comprises a second elastic element, and the second shaft pin is slidably arranged, so as to be inserted into the second wheel by pushing of the second driving slope when the second driver is rotated, or to be withdrawn from the second wheel under an elastic force of the second elastic element.

10. The brake device according to claim 9, wherein the second driver is provided with a driving inclined hole, and the second brake mechanism further comprises a third elastic element providing an elastic force to reset the second driver, and a second operating member having a shaft pin slidably inserted into the driving inclined hole.

11. The brake device according to claim 9, wherein the second driving slope is provided with a locking position at an end thereof and an unlocking position at the other end.

12. The rake device according to claim 1, wherein when the first brake mechanism locks the first wheel, the first brake mechanism drives the second brake mechanism to lock the second wheel, and when the first brake mechanism unlocks the first wheel, the first brake mechanism drives the second brake mechanism to unlock the second wheel.

13. The brake device according to claim 4, wherein the first brake mechanism further comprises an engaging hook, the first driver is provided with a first guide groove and a second guide groove, an engaging position and an unlocking position are arranged between the first guide groove and the second guide groove, a first end of the engaging hook is fixed on a frame of the baby carriage, and a second end of the engaging hook is slidably arranged in any one of the first guide groove and the second guide groove; when the first driver rotates and pushes the first shaft pin to lock the first wheel, the engaging hook slides from the first guide groove to the engaging position; and when the first driver rotates and pushes the first shaft pin to unlock the first wheel, the engaging hook slides from the engaging position to the unlocking position.

14. The brake device according to claim 13, wherein a fixing hole is provided on the frame of the baby carriage, and the first end of the engaging hook is connected to the fixing hole.

15. The brake device according to claim 13, wherein the first driver is further provided with a third guide groove and a fourth guide groove, both ends of the third guide groove are connected with the first guide groove and the engaging position, and both ends of the fourth guide groove are connected with the engaging position and the second guide groove.

16. The brake device according to claim 15, wherein a guide slope is provided between the fourth guide groove and the second guide groove for sliding the engaging hook to the second guide groove.

17. The brake device according to claim 1, wherein the brake device further comprises a driving mechanism arranged on a frame of the baby carriage, the driving mechanism is connected to the first brake mechanism and the second brake mechanism via the traction element and is operated so that the first brake mechanism and the second brake mechanism are driven by the traction element to lock the first wheel and the second wheel, or the first brake mechanism and the second brake mechanism are driven by the traction element to unlock the first wheel and the second wheel.

18. The brake device according to claim 17, wherein the driving mechanism comprises:
a fixed seat arranged on the frame of the baby carriage;
a third driver, having a body portion rotatably arranged in the fixed seat, and extending out of a third operating member; wherein the body portion of the third driver comprises a guide side surface comprising an annular groove, and the annular groove is provided with an engaging groove;
an engaging torsion spring comprising a fixed portion and a torsion spring head extending from the fixed portion, wherein the fixed portion is fixed on the fixed seat, and the torsion spring head is slidably arranged in the annular groove; when the third driver pivots in a first direction and drives the first brake mechanism and the second brake mechanism through the traction element to lock the first wheel and the second wheel, the torsion spring head slides along the annular groove and abuts against the engaging groove; when the third driver pivots in a second direction opposite to the first direction and drives the first brake mechanism and the second brake mechanism through the traction element to unlock the first wheel and the second wheel, the torsion spring head leaves the engaging groove along the annular groove; and
a return torsion spring having a first end fixed to the fixed seat, and a second end fixed to the body portion of the third driver.

19. The brake device according to claim 18, wherein the annular groove comprises a first guide groove and a second guide groove, and the engaging groove and an unlocking groove are arranged between the first guide groove and the second guide groove; and when the third driver is in an initial position, the torsion spring head is located in the unlocking groove.

20. The brake device according to claim 19, wherein an angle between the first guide groove and the unlocking groove is greater than 90 degrees, and an angle between the second guide groove and the engaging groove is greater than 90 degrees.

21. The brake device according to claim 19, wherein a bottom surface of at least one of the first guide groove, the engaging groove, the second guide groove and the unlocking groove is provided to gradually increase from an end of the groove to the other end in a counterclockwise direction, so that a step structure is formed between bottom surfaces of at least two adjacent grooves of the first guide groove, the engaging groove, the second guide groove and the unlocking groove.

22. The brake device according to claim 19, wherein the engaging groove is divided into two sections in an extending direction of the groove, a step structure is formed between bottom surfaces of the two sections, and the bottom surface of the section close to the first guide groove is higher than the bottom surface of the section close to the second guide groove.

23. The brake device according to claim 18, wherein an inner side wall of the engaging groove comprises a recess for positioning the torsion spring head.
